(19) United States
(12) Patent Application Publication
(10) Pub. No.: US 2002/0007421 A1
(43) Pub. Date: Jan. 17, 2002

(54) Universal address system

(76) Inventors: Thomas Dixon, McLean, VA (US); Sean Macisaac, Colorado Springs, CO (US)

Correspondence Address: ANDREW F. BODENDORF, Fish & Richardson P.C., 601 Thirteenth Street, NW, Washington, DC, 20005, US

(21) Appl. No.: 09/849,305

(22) Filed: May 7, 2001

Related U.S. Application Data
(60) Provisional application No. 60/202,078, filed on May 5, 2000.

(51) Int. Cl. G06F 15/173; H04L 12/28

(52) U.S. Cl. 709/238; 370/351

(57) ABSTRACT

A universal addressing method and system allow messages to be sent using any protocol or service by routing the message to a recipient using a universal address. Routing information associated with the universal address for each message service may be easily configured and stored. The routing information also may be quickly and easily modified to change the message delivery location. The system may include a message service provider and a universal address service provider supervised by a universal address authority.

This application claims priority from U.S. Provisional Application No. 60/202,078, filed, May 5, 2000, titled “Universal Addressing System,” which is incorporated by reference.

### TECHNICAL FIELD

The present invention generally relates to an addressing system and in particular to a system for routing messages independently of a particular protocol.

### BACKGROUND

Over the years, different methods of communication services have continually expanded. Now messages may be sent by email, regular-mail, delivery services, pagers, facsimile machines, and wired or wireless phones. Each message is delivered by a communication service to a location, such as, for example, an email address, a residential or business address, a post office box, a pager number, a facsimile number, or a wireless or landline phone number. Before sending a message, a message delivery location must be determined and provided to the communication service that delivers the message to the recipient. However, the message sender may not possess an accurate message delivery location. The message sender also may not know which location to pick among several possible message delivery locations. Likewise, a message sender may not know which message delivery location is the most likely to result in actual delivery of the message to the recipient. As a result, a message sender may have to send messages to multiple message delivery locations to ensure that the message reaches the intended recipient. In addition, time and money may be wasted trying to locate the message recipient to obtain the correct message delivery location. Moreover, a message recipient does not possess a convenient way to inform message senders of the best or preferred message delivery location to send messages, of a change in the message delivery location, or of a newly acquired message delivery location.

### SUMMARY

In one general aspect, universal addressing allows messages to be sent using any protocol or service by routing the message to a recipient using a universal address. Routing information associated with the universal address for each message service may be easily configured and stored. The routing information also may be quickly and easily modified to change the message delivery location.

In another general aspect, routing messages may include receiving a message with a universal address, and sending a request for processing of the universal address to a universal address service provider. Therefore, a message delivery location is received based on the universal address, and the message is routed to the message delivery location.

In yet another general aspect, routing a message may include receiving a universal address and a message type. Next, the identity of the universal address requestor is determined; a database of message delivery locations is accessed; and a message delivery location is determined based on the message type. Finally, the message delivery location is transmitted to the requestor.

In yet another general aspect, a message service provider may include an interface for receiving a message with a universal address, a processor for generating a request to a universal address service provider for a message delivery location based on the universal address, and an interface for receiving the requested message delivery location. The message service provider routes the message based on the received message delivery location.

A universal address service provider may include an interface for receiving a universal address, an interface for receiving a message type, a processor for determining the identity of the universal address requestor and for determining a message delivery location based on the universal address, an interface for sending the determined message delivery location, and a database including message delivery locations. The processor determines a message delivery location based on the universal address message type and transmits the message delivery location to the requester.

A message delivery system may include a message service provider, a universal address service provider, and a universal address service provider authority.

Other features and advantages will be apparent from the description, the drawings, and the claims.

### BRIEF DESCRIPTION OF THE DRAWINGS

FIG. 1 is an exemplary block diagram of a universal address system.

FIG. 2 an exemplary block diagram of a universal address system.

FIG. 3 is an exemplary process for determining a message delivery location.

FIG. 4 is an exemplary process for accessing a universal address database.

FIG. 5 is an exemplary processor for of processing a message with a universal address.

FIGS. 6A-6C illustrate exemplary universal addresses.

FIGS. 7A and 7B are exemplary universal address records.

FIG. 8 is an exemplary tables for use with the universal address system.

Like reference symbols in the various drawings indicate like elements.

### DETAILED DESCRIPTION

Overview

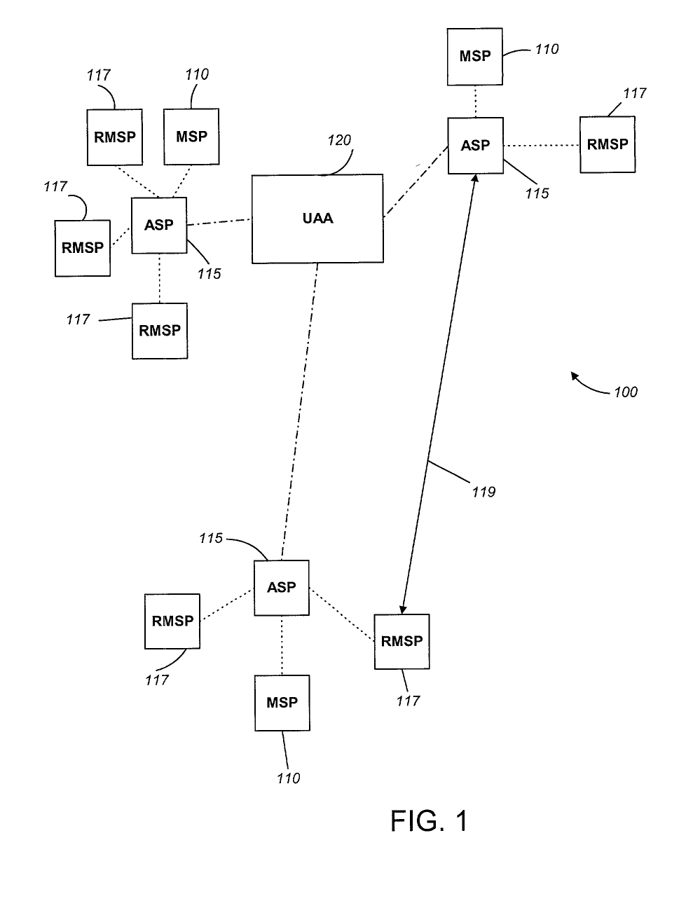

Turning to FIG. 1, a universal address system 100 generally includes a number of message service providers (MSPs) 110 that receive, route, and deliver messages to various geographical areas. Message services that may be used with the universal address system include email, regular mail, and other delivery services, wired or wireless phones, pagers, facsimiles and any method that delivers messages based on a message delivery location or ID. The MSPs 110 may service a local, a regional, a national, or a global population. A number of universal address service providers (ASPs) 115 provide access to universal addresses that are available to the public and the MSPs 110. In addition, a number of message service providers (RMSPs) 117 may register with an ASP 115. The RMSPs 117 are given greater access to universal addresses managed by the ASPs 110. Although an ASP 115 generally services a particular population, MSPs 110 and RMSPs 117 may contact ASPs 110 in any locality or region using, for example, a communications link 119. A universal address authority (UAA) 120 supervises a number of ASPs 115 on a regional, a national, an international, or a global basis. In addition, the UUA provides support for MSPs 110, RMSPs 117, and the universal address system 100 in general.

Universal Address System

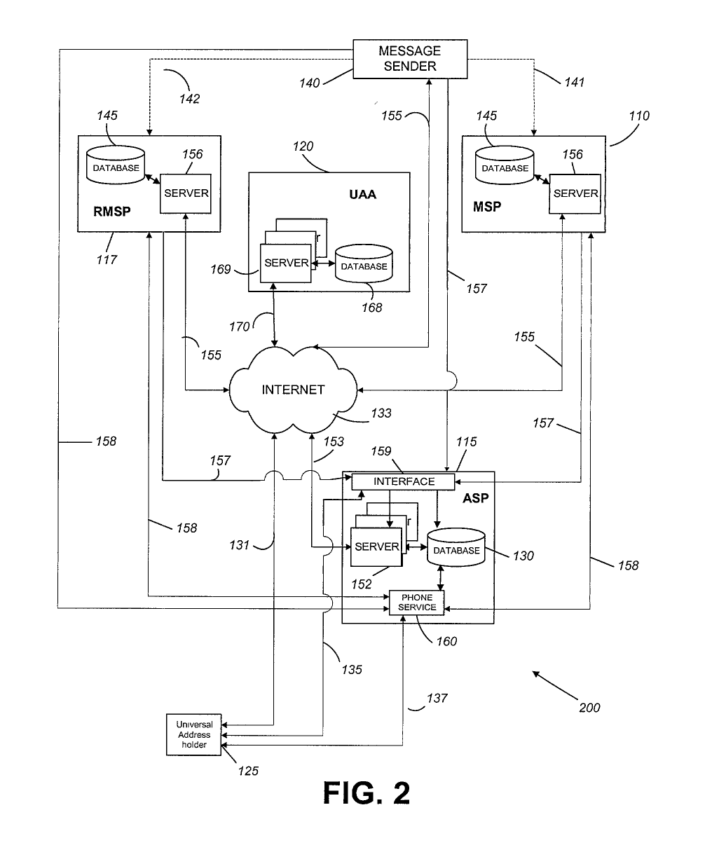

Turning to FIG. 2, a universal address system 200 permits an entity (e.g., an individual or a group of individuals, a company, or an organization) that wants to use the universal address system to apply for a universal address. A universal address is an address that uniquely identifies an entity regardless of the medium or protocol used to send or receive a message. Once a universal address is acquired, the entity is a universal address holder 125. The universal address holder 125 may configure a message delivery location for each type of message service that the universal address holder 125 has.

An entity applies for a universal address from an ASP 115. The ASP 115 assigns universal addresses from a number of available universal addresses based on the application from the entity. After being assigned a universal address, a universal address holder 125 receives an account with a number of configurable message delivery location storage arrays stored in a database 130. The universal address holder 125 may enter the message delivery locations in the storage arrays associated with each message service that the universal address holder 125 uses. Whenever a universal address holder 125 wants to change a message delivery location associated with the universal address, the universal address holder 125 configures the message delivery location stored in the database 130 to reflect the desired change in message delivery location. The universal address holder 125 may contact the ASP 115 to enter, change, or update the message delivery locations using, for example, a communications link 131 to the Internet 133. In addition, the ASP 115 also may be contacted directly using a telecommunications links 135 or 137.

When a sender 140 wants to send a message, or to contact a universal address holder 125, the sender 140 may contact a MSP 110 using a message communications method 141.

The MSP 110 receives the message, or the request to send a message, and processes a message delivery location provided with the message or request. After processing the message delivery location, the MSP 110 routes the message to the determined delivery location using a message delivery process (not shown). If a message including a universal address is received by a MSP 110, the MSP 110 may contact an ASP 115 administering the universal address and request a message delivery location corresponding to the universal address. The ASP 115 checks the database 130 to determine if the message delivery location has been made available for lookup by the MSP 110. If access has been granted, the ASP 115 provides the message delivery location to the requesting MSP 110. If access has not been granted, the MSP 110 replies that the ASP 115 is unable to service the request.

A sender 140 also may send a message through a RMSP 117 using a message communication method 142. A RMSP 117 may process messages with or without a universal address. If the message only includes a message delivery location, the message is processed and routed according to the message delivery location included with the message. However, upon processing a message including a universal address, the RMSP 117 contacts the ASP 115 indicated by the universal address to obtain a corresponding message delivery location. Having obtained the message delivery location, the RMSP 117 processes the message delivery location and routes the message using a message delivery process (not shown). Both the RMSP 117 and the MSP 110 may include a database 145 for storing universal address information.

A UAA 120 may be provided to supervise one or more ASPs 115. The UAA 120 receives and processes applications by any organization that wishes to become an ASP 115. To ensure that each ASP 115 complies with certain operating standards, the UAA 120 may regularly audit each ASP's operations. In addition, the UAA 120 may take over ASP operations in certain situations. The UAA maintains records for the universal address system 200 in a UAA database 168. A UAA server 169 provides access to the database 168 and may be contacted through the Internet 133 and the communication link 170.

Each of the universal address system's constituent parts is described in further detail in the following sections.

Universal Address Service Providers (ASPs)

Each ASP 115 is assigned at least one or more ASP descriptor that uniquely identifies the ASP 115 in the universal address system. The ASP descriptors are administered and assigned by the UAA 120. Each of the universal addresses assigned by the ASP 115 includes an ASP descriptor as described below. Although any entity may be assigned a universal address, each ASP 115 may restrict service to particular types of entities (e.g., individuals or businesses).

The ASP 115 may be regulated by a set of guidelines for assigning universal addresses. According to an exemplary guideline, an ASP 115 may allow a universal address holder 125 to select a user name from a number of available user names. The user name helps identify the universal address holder 125 and is included in the universal address. The ASP 115 may impose additional requirements on the user name. For example, the ASP 115 may require that the user name be descriptive of the universal address holder 125.

Every universal address may have associated contact information that is obtained during the application process. The contact information may include a social security number (SSN), a permanent street address, a permanent billing address, and a permanent telephone number that is associated with the universal address holder. The ASP 115 also may take reasonable steps to verify the validity of this information prior to activating the universal address. The ASP 115 may keep a permanent record of all assigned universal addresses and the associated contact information including the permanent street address, the permanent billing address, and the permanent telephone number, even if the universal address is abandoned. If a universal address is abandoned, the universal address may not be assigned again for a period time such as, for example, a number of years, to avoid confusion or misdirection of messages.

Each ASP 115 may provide one or more universal address servers 152. Each server 152 is assigned an Internet Protocol (IP) hostname by the UAA 120. The servers 152 respond to requests to process universal addresses under the ASP's administration. The requests are received by the servers 152 from a communication link 153 connected to the Internet 133. The server 152 processes the submitted universal address to determine that the request is directed to the correct ASP 115 and that the requestor is authorized to access information associated with the universal address. A RMSP 117, MSP 110, or a sender 140 may contact the server 152 using a communications link 155 to connect to the Internet 133.

The server 152 processes the universal address and accesses database 130 to obtain a message delivery location corresponding to the message service desired by the requestor. If the requestor is a sender 140 or an unregistered MSP 110, the ASP 115 may return a message delivery location that universal address holder 125 has authorized for public access. If the request is made by a RMSP 117, an identification (ID), a key, or a certificate may be provided with the request. Using the identification, the ASP 115 may verify the identity of the RMSP 117 and return a message delivery location for the desired message service.

The message delivery location may be encoded in packets according to the IP/TCP protocol, and may be sent to a server/processor 156 at the RMSP 117 or the MSP 110, the UAA server 169, or a browser of the message sender 140, through the Internet 133. For added protection, each of the packets also may be encrypted with a key or certificate. If the packets are encrypted, the receiving server or browser decrypts and decodes the packets with software provided by the ASP 115 or the by UAA 120. The message delivery location also may be requested and/or sent to the RMSP 117, MSP 110, and message sender 140 using telecommunication links 157 or 158. The server 152 also responds to requests from a universal address holder 125 to access or update information associated with the universal address. Upon registration, a universal address holder 125 is provided with software for a browser and/or graphic user interface allowing the universal address holder 125 to communicate with the server 152. Upon contacting the server 152, the universal address holder 125 is required to enter a password or provide an ID, key, or certificate to verify the universal address holder's 125 identity. After verifying the entity's password, ID, key, or certificate the server, 152 provides access to the database 130. Once granted access, the universal address holder 125 may set, add, and change message delivery locations stored in the ASP database 130 using a graphic user interface and/or the browser. For example, the universal address holder 125 may be presented with a menu of message service types. The universal address holder may choose a message service type and then enter or change the message delivery location associated with selected message type. The message service type may be broken into subcategories. For example, the message service type for phones may be divided into a business phone; a mobile phone, and a home phone.

The ASP 115 may include a number of other interfaces that allow a universal address holder 125 to update and change access to the message delivery locations. For example, the ASP 115 may include an interface 159 that allows a universal address holder 125 to directly communicate with the ASP 115. The interface 159 may include a modem or other communications device that allows the universal address holder 125 to communicate with the ASP 115 directly using communications link 135. The interface 159 provides access to the server 152 or the database 130. MSPs 110, RMSPs 117, and message senders 140 also may contact the answering service 160 through communications links 158 to look up message delivery locations provided that proper ID is given and/or access has been granted by the universal address holder 125.

The ASP 115 also may include a phone answering service 160. The answering service 160 may be automated, staffed by ASP service representatives, or a combination of both. If automated, a universal address holder 125 may dial into the answering service 160 using communications link 137 and access the message delivery location data in database 130 using touch-tone signals of a phone to navigate through a menu of options. Likewise, service representatives may answer calls and access the database to assist universal address holders 125. In either case, the universal address holder 125 is required to provide proper identification before access to the database 130 is granted.

In addition to setting a message delivery location for each message delivery service type, the ASP 115 allows universal address holders 125 to determine the accessibility of a message delivery location. Using a browser, the universal address holder may determine whether the message delivery location may be accessed by: anyone trying to determine a message delivery location, all MSPs 110, all RMSPs 117, specific entities, or a combination of these activities. The universal address holder 125 may individually set the access to a message delivery location for each message service type.

Each ASP 115 may back up its database 130, for example, on a daily basis in addition to keeping archived data. Furthermore, the ASP 115 may maintain multiple servers 152 to provide adequate capacity to handle requests from senders 140, MSPs 110, RSMPs 117, and universal address holders 125, or as a backup in case of server failure. Exact efficiency and reliability standards may be determined by the UAA 120 and revised as server use changes.

The information stored with an ASP 115 may be sensitive in nature. For this reason, ASPs 115 may operate under specific and stringent guidelines designed to protect universal address holder's privacy. Exact guidelines can be established by the UAA 120. Examples of the guidelines include: ASP employees should use any data to which they are exposed in an authorized manner consistent with their official position; ASP employees should not distribute, share, or use the information for any personal or nonofficial purpose; ASP employees whose position entails incidental contact with information in the ASP database 130 should deal anonymously with any data they encounter; and ASP employees who look up universal address holder 125 records should do so only when they have received an explicit service request from the universal address holder 125. The universal address holder 125 may be made aware of what information the ASP employees see and agree to such inspection in advance. The universal address holder 125 should have the option of restricting the lookup of account information before access is granted to the message delivery location with the understanding that not all message service requests can be handled under such a restriction. The ASP 115 may provide for other different or specific customer requests about lookup restriction.

Each ASP 115 may take measures to ensure that data cannot be accessed by any unauthorized party or in an unauthorized manner. Exact guidelines can be established by the UAA 120, but may include that any access to universal address information must include a method to authenticate that the requester should be given access to the information. ASPs 115 should ensure that accessed universal address information is documented. A universal address holder 125 may specify that the data is accessible by, for example, any specified party, any party with a certain password, all services registered for that message service type, or only certain services registered for that message service type. In addition, access to the ASP 115 from the Internet 133 may be protected by firewalls and other protective measures including exterior screen routers, choke routers, and/or a bastion host (not shown).

An ASP 115 may charge a universal address holder 125 for providing service for the assigned universal address according to a system created by the ASP's. Charges may include: initial fees for setup, fees for service over a time period, fees for changes to a message delivery address, fees based on the number of times the universal address is processed, and other reasonable fees.

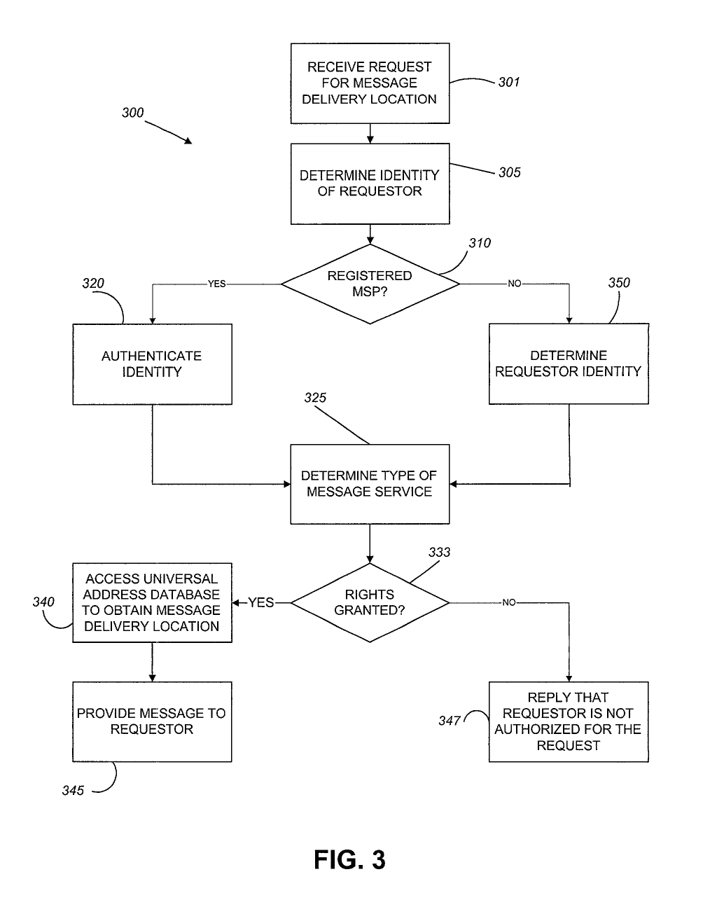

Turning to FIG. 3, according to an exemplary process 300 for determining a message delivery location, a request for a message delivery location is received at the ASP 115 (step 301). The request may include a universal address. An identification (in the form of an ID, key, or certificate) also may be presented in addition to a message type. The received information is decoded and/or decrypted by the ASP 115 (if necessary). The identity of the requestor is determined (step 305) and the ASP determines if the requestor is an RMSP 117 (step 310). If the requestor is an RMSP 117, the ASP 115 authenticates the identity of the RMSP 117 (step 320). If the authentication is not valid, the RMSP 117 may be given additional chances to verify the identity. If the identity cannot be verified, access is denied (not shown). If the identity of the RMSP 117 is authenticated, then the ASP 115 determines what message type is being requested (step 325). After determining the message type, the ASP 115 determines if access has been restricted for the message service type (step 333). If access has not been restricted, the ASP 115 accesses the universal address database 130 to obtain a message delivery location corresponding to the message type (step 340) and provides the message delivery location to the requester (step 345). If access is not granted, the ASP 115 replies that the requestor is not authorized to access the message delivery location (step 347).

If requester is not a RMSP 117, the requestor's identity is determined (step 350). The message service for which the delivery address is sought also is determined (step 325), and the procedure proceeds as discussed above.

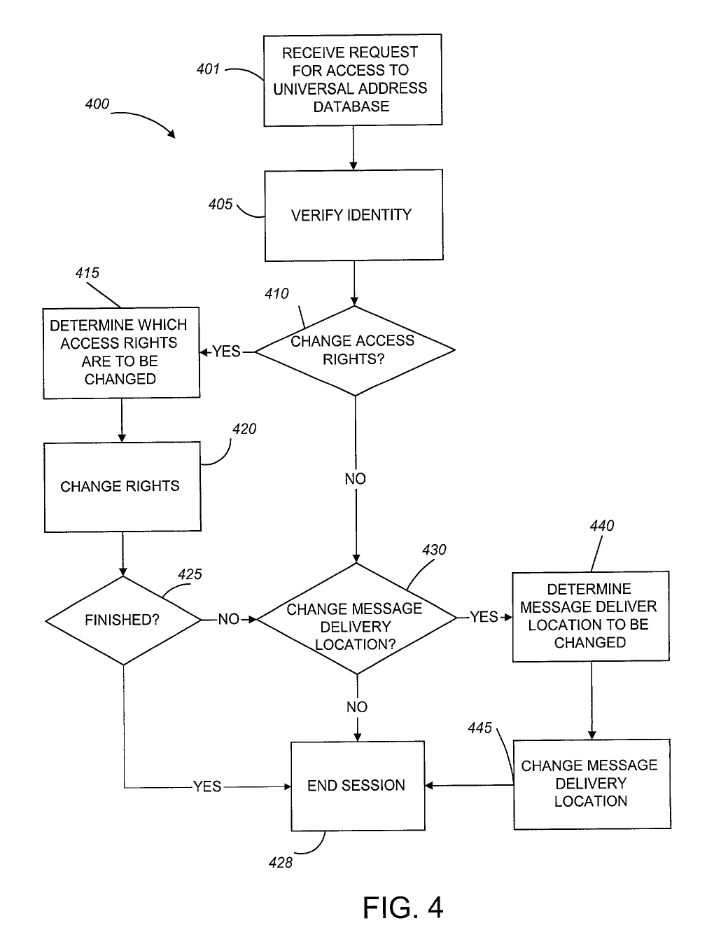

Turning to FIG. 4, according to an exemplary method 400 for accessing a universal address database 130 by a universal address holder 125, an ASP 115 receives a request to access the universal address database 130 (step 401). The ASP 115 verifies the identity of the universal address holder 125 (step 405). If the identity of the universal address holder 125 is verified, the ASP 115 determines if the universal address holder 125 wants to change access rights for the universal address (step 410). If the universal address holder 125 wants to change access rights, the ASP 115 determines which message delivery location access rights are to be changed (step 415) and then changes the access rights as instructed (420). The ASP determines if the universal address holder 125 is finished (step 425), and, if so, ends the session (428). If not, the ASP determines if the universal address holder wishes to change a message delivery location (step 430).

If the universal address holder 125 does not want to change access rights (step 410), the ASP determines if the universal address holder 125 wants to change message delivery locations (step 430). If the universal address holder 125 does not want to change any message delivery locations, the ASP 115 ends the session (step 428). If the universal address holder 125 wants to change message delivery locations, the ASP 115 determines which message delivery locations are to be changed (step 440) and changes them as instructed (step 445). The ASP 115 then ends the session (step 428).

Messaging Service Providers (MSPs)

Any organization that accepts and delivers or routes messages is considered a MSP 110. Examples of MSPs 110 include the U.S. Postal service, delivery services (e.g., UPS, Federal Express, DHL), wired or wireless telecommunication companies (local and long distance), and Internet service providers. Any MSP 110 may accept universal addresses from their customers to address messages. Any MSP 110 may process universal addresses that are authorized by the universal address holder 125 for general lookup, MSP 110 lookup, or if specifically designated for lookup.

RMSPs 117 that register with the UAA 120 to provide message delivery for certain services (e.g., wired or wireless phone, pager, facsimile, email, regular mail, and delivery services) are authorized to access one or more of the message delivery locations supported by the RMSP 117 that have not been specifically restricted from lookup by the universal address holder 125. By registering with the UAA 120, the RMSP 117 gains the advantage of being able to access delivery addresses that are restricted to RMSPs 117. Because registered RMSPs 117 may be authorized to access message delivery locations that are not available to the general public, the RMSPs 117 may be subject to confidentiality restrictions on the information they receive from the ASP servers 152 and universal address database 130.

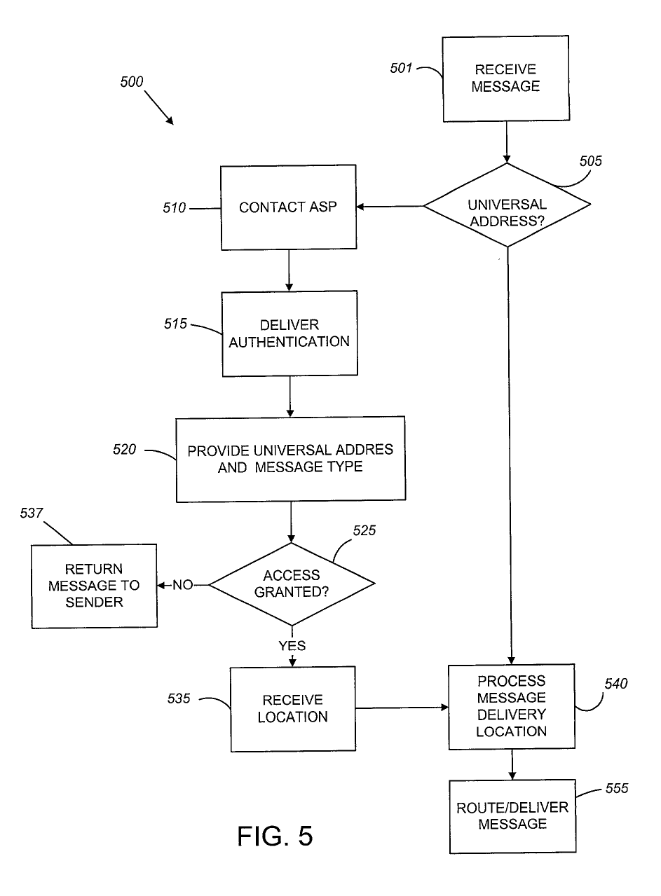

Turning to FIG. 5, according to an exemplary message processing method 500, a RMSP 117 receives a message through a message communication method (e.g., email, regular mail, delivery service, pager, wired or wireless telephone, or facsimile) (step 501). The RMSP 117 processes, the message to determine if the message contains a universal address (step 505). If the message contains a universal address, the RMSP 117 contacts an ASP 115 using an ASP descriptor included with the universal address (step 510). The RMSP 117 also delivers an identification for authentication (step 515). After the ASP 115 authenticates the ID, the RMSP 117 provides a universal address and message service type (step 520). The RMSP 117 receives a determination if access has been granted for the message delivery location corresponding to the universal address (step 525). If access is not granted, the RMSP 117 returns a message to the sender 140 that the RMSP 117 is unable to deliver the message (step 537). If the access is granted, the RMSP 117 receives the message delivery location (step 535). The RMSP 117 processes the message delivery location to determine how to route the message (step 540). The RMSP 117 then routes or delivers the message (step 555).

If the message does not contain a universal address, the RMSP 117 processes the message delivery location included with the message to determine how to route or deliver the message (step 540). The RMSP 117 then routes or delivers the message according to a message delivery process (step 555).

Universal Address Authority (UAA)

A UAA 120 may supervise a number of ASPs 115. The UAA 120 receives and processes applications from any organization that wishes to become an ASP 115. In addition, the UAA 120 also processes applications by MSPs 110 to become RMSPs 117.

The UAA 120 may provide a web page with information about becoming an ASP 115 and to facilitate the filing of an application to become an ASP 115. The requirements for becoming an ASP 115 may be stringently and strictly enforced by the UAA 120. If an applicant is accepted, the UAA 120 may quickly provide the ASP 115 with all information and software needed to begin operation. Similarly, the web page may contain information about becoming a RMSP 117.

After an ASP 115 has been approved, the UAA 120 assigns a unique ASP descriptor to the ASP 115. The newly approved ASP 115 may select any available ASP descriptor. The ASP 115 may request additional ASP descriptors from the UAA 120 as needed to handle additional universal address holders 125.

Each ASP 115 registered with the UAA 120 may provide the UAA 120 with IP server names for the one or more servers 152 that process universal addresses administered by the ASP 115. The UAA 120 may a maintain database 168 including each ASP descriptor and associated ASP IP server name. The database 168 may be publicly available and contacted using the UAA server 169. The UAA server 169 may be accessed through the Internet 133 and communications link 170.

The UAA 120 also processes requests by MSPs 110 to become RMSPs 117. If the MSP is approved and registered, the UAA 120 assigns a text description to the RMSP 117 clearly identifying the RMSP 117. The UAA 120 also assigns a unique ID for the RMSP 117, which is used to identify the specific RMSP 117 for authorization and tracking purposes. The UAA 120 may distribute a certificate, key, or ID to the registered MSP 117. The certificate, key, or ID is used for authentication when accessing the ASP 115 to process a universal address and corresponding request for a message delivery location.

The UAA 120 also maintains in a database 168 records for all RMSPs 117, including their text descriptions, IDs, and digital certificates or keys. The database 168 also contains information about which message service types and message delivery location types that the each RMSP 117 supports. The message service type information may be made publicly available through the UAA servers 169. The UAA 120 may provide a secure web interface through server 169 so that all RMSPs 117 can update information about their support for services and delivery address types maintained in the UAA database 168.

The UAA 120 also processes applications filed by RMSPs 117 to register new message service types for use with universal address system. Any proposed message service that meets the characteristics of a message service supported by the universal address system may be registered as an authorized message service provided that, for example, the message service is not already supported by a more general registered service. In addition, the message service's implementation should not require any modifications to the universal address system. If either of these conditions is not met, the UAA 120 may reject the service or, at its discretion, make arrangements to support the new message service. The UAA 120 also may process applications by any RMSP 117 to register a new message delivery location type for use with the universal address system.

The UAA 120 may provide a number of administrative and computing services that directly and indirectly support the universal address system. The UAA 120 also may be responsible for creating and updating ASP descriptors, ASP names, RMSP names/IDs, and universal address holder IDs.

To ensure that each ASP 115 and RMSP 117 complies with certain operating standards, the UAA 120 may regularly audit ASP 115 and RMSP 117 operations. Examples of audits include: contacting the ASP 115 or RMSP 117 to review operations, testing the ASP 115 by registering universal addresses and accessing the ASP 115 for universal address locations routing, reviewing web pages and other published material produced by the ASP 115, and attempting to penetrate ASP security measures to detect any weaknesses. The UAA 120 also may field complaints from universal address holders 125 regarding disputes that could not be resolved with the ASP 115.

In the event that an ASP 115 is unable to continue operation, the universal addresses administered by the ASP 115 may be serviced by the UAA 120. For example, in the event that an ASP 115 discontinues operation, the UAA 120 may conduct an auction among the remaining ASPs 115 or an ASP applicant to buy the universal addresses serviced by the defunct ASP. The highest bidder can assume responsibility for the ASP descriptors that were administered by the defunct ASP. Affected universal address holders 125 may be given the option of switching to the highest bidding ASP, switching to another ASP, or discontinuing service altogether. If the universal address holder 125 decides to switch to another ASP, the universal address holder 125 may be assigned a new universal address by the new ASP. The administrator of the entity's old universal address must redirect requests to process the universal address to the UAA 120 for a period of time, such as, for example, one year. The UAA 120, in turn, may forward the message delivery location request to the appropriate ASP 115 for the period of time. The entity is responsible for distributing any new universal address to all senders 140 before the period of time expires. After that time, the old ASP descriptor administrator and/or the UAA 120 are no longer responsible for redirecting requests to process the old universal address.

Addressing Scheme

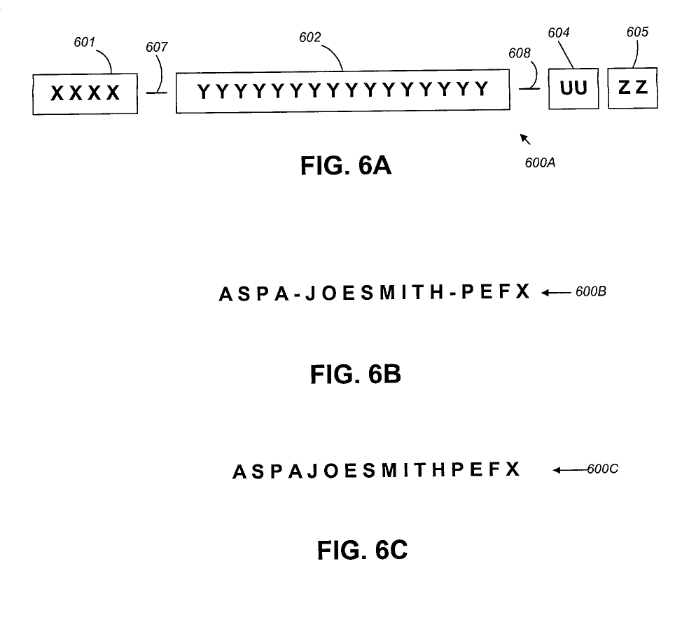

Turning to FIG. 6A, an exemplary universal address 600A includes four parts: an ASP descriptor 601, a user name 602, a user ID 604, and a checksum 605. The ASP descriptor 601 includes a number of characters, for example, four characters that uniquely identify an ASP that administers the user ID 604. The user name 602 may include a number of characters, for example, 6-20 characters, and may be assigned by the ASP 115. The user ID 604 may include two characters, which also may be assigned by the ASP 115. The checksum 605 may include, for example, two characters that are derived from the ASP descriptor 601, the user name 602, and the user ID 604. To minimize possible errors and confusion, upper case letters A through Z are used for universal addresses; however, other characters also may be used.

When the universal address is presented for processing at a MSP 110 or a RMSP 117, only the alphanumeric characters that make up the four parts of the address need to be included. However, the universal address may include one dash 607 separating the ASP descriptor 601 from the user name 602 and one dash 608 separating the user name 602 from the user ID 604 and checksum 605.

According to the example shown in FIG. 6A, the ASP descriptor 601 may include four characters that uniquely identify the ASP 115 managing the universal address. The ASP 115 may use the same four characters for all universal addresses that the ASP 115 manages. However, multiple ASP descriptors 601 may be assigned to the same ASP 115, if necessary, to accommodate a large number of universal address holders 125. A MSP 110 or a RMSP 117 uses the ASP descriptor 601 to determine where to obtain a message delivery location associated with a universal address. The ASP descriptor 601 is assigned by a UAA 120.

The user name 602 includes, for example, sixteen characters that may be assigned by the ASP 115. ASPs 115 may allow an entity to select a user name 602 from available user names 602 in combination with a user ID 604. The user name 602 may correspond to, for example, a person's name or a company's name.

The user ID 604 includes two letters assigned by the ASP 115. The ASP 115 may use the user ID 604 to distinguish between entities that have or desire the same user name 602. For example, the first two letters of a user's middle name may be used as a user ID 604.

The checksum 605 may include, for example, two letters assigned by the ASP 115. The value of the characters of the checksum may be determined from the other parts of the universal address. For example, when a universal address is processed by a MSP 110 or a RMSP 117, the MSP 110 or RMSP 117 may apply an algorithm to determine if the universal address is valid. If an error has occurred during the communication of the universal address, or the MSP 110 or RMSP 117 made an error reading the address, processing the checksum 605 will return an invalid universal address. As a result, a MSP 110 or RMSP 117 may determine with great certainty if a universal address is correct. In addition, the chance that the message associated with the universal address is incorrectly routed is significantly reduced. The checksum 605 may be generated by any of the well known methods for creating checksums.

FIG. 6B shows an example of Joe Smith's universal address 600B “ASPAJOESMITH-PEFX.” In this case, the ASP 115 administering the universal address is ASP “A.” The user name is Joe P. Smith and the user ID is PE (the first two initials of the Joe's middle name). While dashes 607 and 608 may be used to increase readability of the universal address, a universal address written without dashes may be used as a valid and unambiguous universal address as shown in FIG. 6C. In addition, individuals and organizations may decide to use other notations to communicate the universal addresses. For example, the use of additional punctuation or symbols to separate the characters of the universal address, or lower case letters may be used. According to one example, a universal address using alternative notations may be stripped of the notations to create a valid universal address.

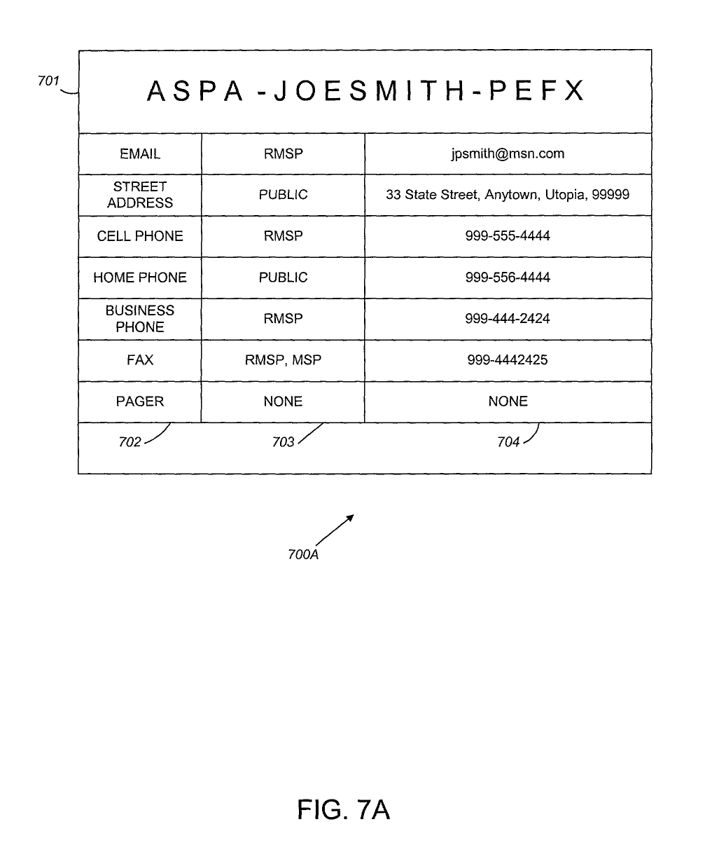

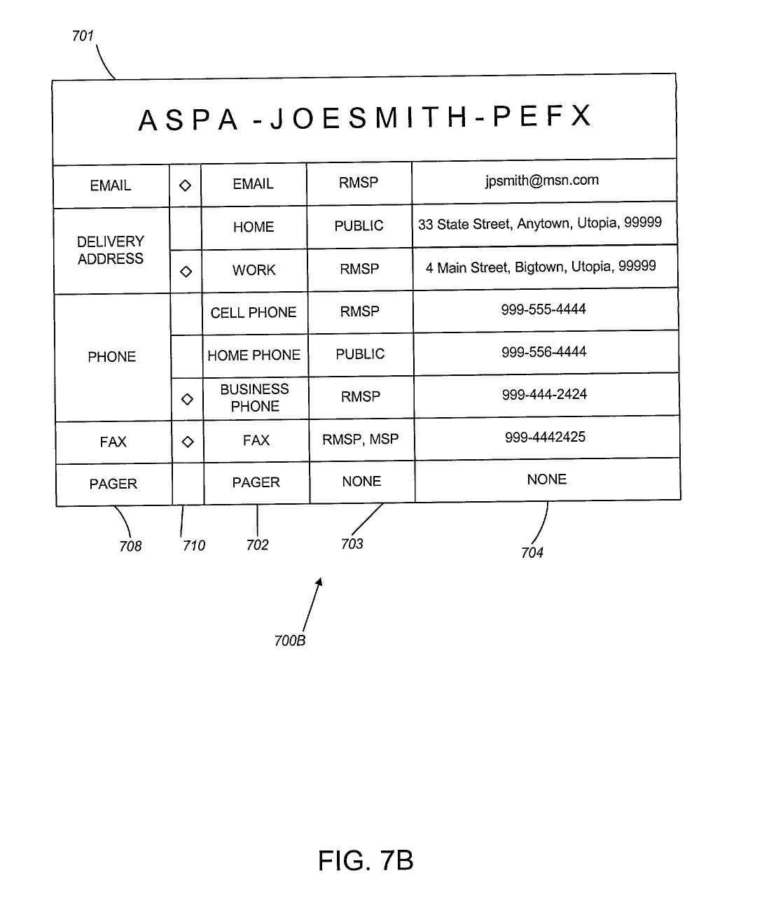

FIG. 7A shows an exemplary record 700A for a universal address for Joe P. Smith. The record 700 may be stored, for example, in the universal address database 130 and/or the UAA database 168. The record 700 includes the universal address 701. In addition, the record contains a message type 702, an access type 703, and a message delivery location 704. The message type 702 identifies the type of message service that corresponds to the message delivery location. As shown in FIG. 7, the message types 702 include email, street address, a cell phone, a home phone, a business phone, a fax, and a pager. These message types 702 may be provided as a default to the universal address holder and may be based on the most commonly used message types. However, additional message types may be added by the universal address holder 125 and placed in the record. The access rights 703 designate whether a RMSP 117, and a MSP 110, or the public (i.e., RMSPs, MSPs, senders, and other entities) will be granted access. In addition, specific RMSPs 117 and MSPs 110 may be designated by the universal address holder 125 and stored as an access type 703 in the record 700. Associated with each message type 702 is a message delivery location 704. As shown in record 700, the message service “email” may be accessed by RMSPs 117 and has the message delivery location “jpsmith@msn.com.” In addition, the message service “home phone” may be accessed by the public and has a message delivery location of “999-556-4444.” In contrast, the default message service “pager” is unused and has no associated access rights or message delivery location.

FIG. 7B shows another exemplary record 700B for a universal address for Joe P. Smith. The record includes a message type 702, an access type 703, and a message delivery location 704. In addition, the record includes a message category 708. The message category indicates a particular type of message service (e.g., email, delivery address, phone, facsimile, and pager). The message types 702 are grouped according to message category. For example, the phone category includes the message types mobile phone, home phone, and business phone. A forwarding marker 710 is used to indicate to which message type within a message category the universal address holder 125 wants messages to be delivered. In the record 700B, phone messages are sent to a business phone number.

Using the record 700B to store universal addresses allows a universal address holder 125 to update where all messages should be delivered from among the available message types 702 that the universal address holder 125 uses. In this way, a universal address holder may conveniently forward all messages, for example, to the universal address holder's current location. In addition, the universal address holder's message devices, for example, a phone, may be programmed to automatically contact the ASP 115 to activate a forwarding marker 710, for example, upon use or activation of the device. For example, a universal address holder 125 could program a mobile phone to automatically dial the ASP 115 and transmit an ID and message type that actives the forwarding marker 710. As a result, all phone messages would be delivered to the universal address holder's mobile phone.

Services

The universal address system may be used with any message service that routes messages between parties based on one or more types of message delivery location types. If a MSP 110 does not support universal addresses internally, the universal address may be used as a lookup service. When using a RMSP 117, a sender 140 may include the universal address instead of the message delivery location when addressing the message.

Some message services may not have any built-in support for a universal address. In such cases, the universal address holder 125 may set a message delivery location for that service in the ASP database 130 and specify that the message delivery location may be looked up directly by all senders 140 or authorized senders (i.e., manual lookup-level I). Although a sender 140 may not look up a delivery location for a universal address every time the sender 140 wants to send a message, the lookup service may be useful to a sender 140 who knows the universal address but not the message delivery location for a particular message service. If a sender 140 has trouble reaching the universal address holder 125 through one message service location, wants to try another location, or wants to verify that a message delivery location is correct, the sender 140 may use the universal address for lookup, for example, to confirm the message delivery location before sending a message.

Some MSPs 110 may not be internally set up to process universal addresses with their own delivery address scheme, but the devices that are used to send messages through their message service may contact the ASP server 152 directly and process the universal address before sending the message (i.e., sending device lookup-level II). For example, a portable telephone supporting mobile TCP/IP allows senders 140 to store universal addresses instead of phone numbers in the phone's internal address book. When the sender dials one of the numbers, the phone may contact the appropriate ASP 115, provide the universal address for processing, receive a message delivery location from the ASP 115, and dial (and/or store) the number provided as the message delivery location.

Message services that are set up internally to support universal addresses (RMSP 117) accept messages addressed with a universal address. The message service should internally process the universal address and deliver the message using a determined message delivery address (message service provider internal forwarding-level III).

Delivery Services

Commercial delivery services such as FedEx, UPS, DHL and Airborne Express can greatly increase service value to customers by supporting the universal address system. Packages sent to a universal address are automatically routed when the permanent address of a universal address holder 125 changes. If the universal address holder 125 provides the ASP 115 with updated message delivery locations, a delivery service can redirect packages on a day-to-day basis. In addition, because delivery locations for universal addresses are provided by the recipient, the message delivery location has a greater likelihood of being correct. This significantly reduces costs incurred by incorrect, nonexistent, or illegible addresses.

By implementing the universal address system, the United States Postal Service (USPS) may greatly increase value to its millions of customers. Senders 140 will be able to write a universal address instead of a postal address on any letter or package, place the package with the USPS, and expect the message to be delivered to the intended recipient no matter where the recipient is. Although, the USPS may not be expected to reroute first class mail to a recipient who is at an alternate location for a few days, if the recipient is at a different location for a longer period of time, for example, weeks or months, mail can be rerouted temporarily. The universal address system also simplifies redirecting maill when a user's permanent mailing address changes.

Email

When an email is sent, an MSP/RMSP processes the universal address to derive an actual email address by contacting the appropriate ASP server 152. The email address is placed in the email and the email is forwarded as usual. Universal addresses can be redirected to any type of email address including, for example, SMTP and X.400. Each different address type is simply considered a different message delivery address type or location. In addition, email has level II support for universal addresses. In this case, a client operating on a sender's device contacts the ASP 115 directly, submits a universal address, and receives an email address in return. The received email address may be used by the device to send the email.

Telephone

With telephone support for universal addresses, a universal address holder 125 may change the phone number registered with an ASP 115 automatically or manually on a frequent basis. The universal address holder 125 may have their calls sent to their home, their office, their mobile phone, or the hotel at which they are staying and may change the number from minute to minute. Devices such as office phones or cellular phones may even change a user's telephone delivery address automatically when they are picked up or activated.

Telephone support for universal addresses may be provided at level II. Devices that can make telephone calls and also have TCP/IP connectivity dial a universal address by first processing the universal address with the ASP 115 and then dialing the returned phone number. These devices allow users to store a list of contacts and their universal addresses so that the user does not have to input an entire universal address every time the user wants to make a call. Devices with this sort of support include portable digital telephones with TCP/IP connectivity and telephones that are directly connected to a computer with TCP/IP connectivity. Telephones that are integrated with a larger phone system also may provide universal address resolution. In addition, for a sender 140 without a compatible dialing device, lookup service for telephone numbers associated with universal addresses may be useful, for example, if the sender has trouble reaching the universal address user at a telephone number.

Level III telephone support for universal addresses also may be provided for callers with existing telephones and/or telephones without an Internet connection. A phone service may accept universal addresses, process the universal address, and forward calls appropriately. Telephone companies may accept universal addresses directly from telephone devices.

Universal Address Tables

A message service is a way of sending messages of a certain general type. For example, the message service “package delivery” is a way of sending packages and regular mail. Similarly, the message service phone is a way of sending telephone calls. Messages may have message delivery location types that can be used to route a message. For example, a street address, a phone number, and e-mail address are all message delivery location types.

A message delivery location is a specific address that the universal address holder has configured in the ASP database 130. For example, one message delivery location for Joe P. Smith may be “33 State St. Anytown, Utopia, 99999.” This message delivery location is of the message delivery location type street address.

There may be a one-to-one correspondence between message services and message delivery location types, that is, a given message service routes messages to message delivery locations with a given message delivery location type. However, this is not always the case. For example, a package delivery service may route messages to message delivery locations of the message delivery location types street address, FedEx shipper number, and UPS shipper number.

A message service is compatible with a message delivery location type, if the messages sent using the message service may be routed to a message delivery location of that message delivery location type. For example, the service package delivery is compatible with the message delivery location types street address, FedEx shipper number, and UPS shipper number.

An MSP 110 or RMSP 117 provides one or more message services. For each message service, the MSP 110 or RMSP 117 accepts a subset of the message delivery location types compatible with the message service. For example, FedEx accepts message delivery locations of the message delivery location type street address and FedEx shipper number.

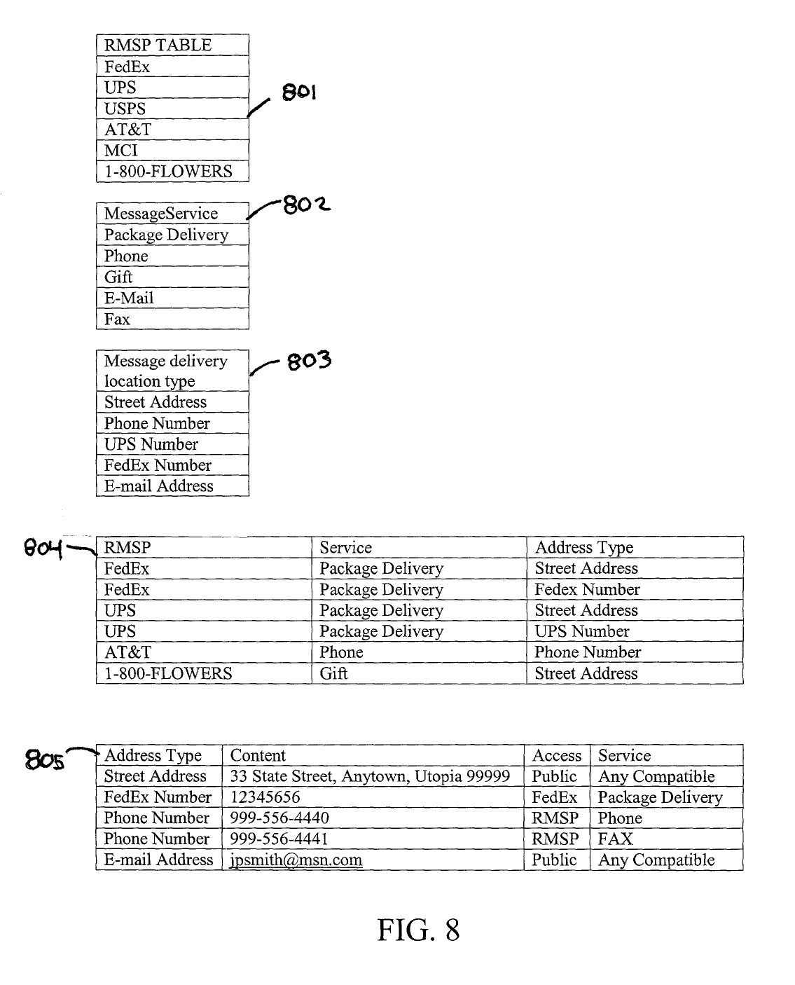

As shown in FIG. 8, a number of exemplary tables that may be stored for the universal address system include: a RMSP table 801; a message service table 802, a message delivery location type table 803; a service provider table 804; a universal address configuration table 805. These tables may be stored in the ASP 115 and/or UAA 120. The tables may be used by the universal address system to route messages.

The universal address configuration table 805 includes exemplary configuration information for a specific universal address holder ASPA-JOESMITH-PEFX. The universal address holder indicates that the street address listed can be accessed by anyone, and that it should be provided for any message service compatible with the message delivery locations of type street address. There are two message delivery locations of type phone number, but the universal address holder 125, in the example, indicates which message delivery location should be provided for the phone service and which should be provided for the FAX service. Both can only be accessed by MSPs registered to provide the phone service.

A number of implementations have been described. Nevertheless, it will be understood that various modifications may be made. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method for routing messages comprising:
receiving a message with a universal address;
sending a request for processing the universal address to a universal address service provider;
receiving a message delivery location based on the universal address; and
routing the message to the message delivery location.

2. The method of claim 1 wherein sending the request comprises sending a universal address service provider descriptor and user name.

3. The method of claim 1 wherein sending the request comprises sending a message type, universal address service provider descriptor, and user name.

4. The method of claim 1 wherein sending the request comprises sending a message service provider identification.

5. The method of claim 4 wherein receiving a message delivery location is based on the message service provider identification.

6. The method of claim 1 wherein receiving a message with a universal address comprises receiving one of a letter and a package.

7. The method of claim 1 wherein receiving a message with a universal address comprises receiving one of a phone number, a pager message, and a facsimile.

8. The method of claim 1 wherein receiving a message with a universal address comprises receiving an email.

9. A method for routing a message comprising:
receiving a universal address;
receiving a message type;
determining the identity of the universal address requester;
accessing a database of universal addresses;
determining a message delivery location based on the message type; and
transmitting the message delivery location to the requestor.

10. The method of claim of claim 9 further comprising determining that the identity has been granted access to the message delivery location wherein the transmitting is performed only if it is determined that access has been granted.

11. The method of claim 9 further comprising receiving a request to change the message delivery location; and storing a new message delivery location.

12. The method of claim 9 wherein determining the message delivery location comprises selecting one message delivery location from a plurality of message delivery locations associated with the universal address.

13. The method of claim 9 wherein receiving the universal address comprises receiving a universal address service provider descriptor and user name.

14. The method of claim 1 wherein determining the identity of the universal address requester comprises receiving a message service provider identification.

15. The method of claim 14 wherein accessing the database of universal addresses comprises determining if the message service provider has been granted access to the message delivery location corresponding to the universal address.

16. The method of claim 9 wherein determining the message delivery location comprises determining an address.

17. The method of claim 9 wherein determining the message delivery location comprises determining one of a phone number, a pager number, and a facsimile number.

18. The method of claim 9 wherein determining the message delivery location comprises determining an email address.

19. A message service provider comprising:
an interface for receiving a message with a universal address;
a processor for generating a request to a universal address service provider for a message delivery location based on the universal address; and
an interface for receiving the requested message delivery location, wherein the message service provider routes the message based on the received message delivery location.

20. The message service provider of claim 19 wherein the processor includes a server connected to the Internet.

21. The message service provider of claim 19 further comprising an interface for sending the generated request wherein the request comprises a universal address service provider descriptor and user name.

22. The message service provider of claim 19 further comprising an interface for sending the generated request wherein the request comprises a message type, universal address service provider descriptor, and user name.

23. The message service provider of claim 19 further comprising an interface for sending the generated request wherein the request comprises a message service provider identification.

24. The message service provider of claim 23 wherein the requested message delivery location is also based on the message service provider identification.

25. The message service provider of claim 19 wherein receiving a message with a universal address comprises receiving one of a letter and a package.

26. The message service provider of claim 19 wherein the received message with a universal address comprises one of a phone number, a pager message, and a facsimile.

27. The message service provider of claim 19 wherein the received message with a universal address comprises an email.

28. A universal address service provider comprising:
an interface for receiving a universal address from a requester;
an interface for receiving a message type;
a processor for determining an identity of the requester and determining a message delivery location based on the universal address;
an interface for delivering the message delivery location to the requestor; and
a database including message delivery locations, wherein the processor determines a message delivery location based on the universal address message type.

29. The method of claim of claim 28 wherein the processor determines that the requestor has been granted access to the message delivery location and transmits the message deliver location to the requestor when access has been granted.

30. The method of claim 28 wherein the processor receives a request to change the message delivery location and stores a new message delivery location in response to the request.

31. The method of claim 28 wherein the processor selects one message delivery location from a plurality of message delivery locations associated with the universal address based on the message type.

32. The method of claim 28 wherein the processor uses a user name to determine the message delivery location.

33. The method of claim 28 wherein determining the identity of the requestor comprises receiving a message service provider identification.

34. The method of claim 28 wherein determining the message delivery location comprises determining an address.

35. The method of claim 28 wherein determining the message delivery location comprises determining one of a phone number, a pager number, and a facsimile number.

36. The method of claim 28 wherein determining the message delivery location comprises determining an email address.

37. A message delivery system comprising:
a message service provider;
a universal address service provider; and
a universal address service provider authority for managing the message delivery system, wherein the message service provider accesses the universal address service provider to determine a message delivery location.

38. A method for updating an address comprising:
receiving a universal address;
receiving an identification;
determining whether the identification is valid;
accessing a database of universal addresses if the identification is valid; and
automatically changing a marker for a message delivery location for the received universal address associated with a message service from a first message delivery location to a second message delivery location.

39. A device for sending messages comprising:
a memory for storing a universal address;
a interface for sending the universal address to a universal address service provider;
an interface for receiving a message delivery location associated with the universal address from the universal address service provider; and
a processor for sending a message with the received message delivery location.
